(19) United States
(12) Patent Application Publication
(10) Pub. No.: US 2007/0077329 A1
(43) Pub. Date: Apr. 5, 2007

(54) Injection molding machine

(76) Inventor: Yoshihiro Okumura, Toyohashi-shi (JP)

Correspondence Address: BRINKS HOFER GILSON & LIONE, P.O. BOX 10395, CHICAGO, IL, 60610, US

(21) Appl. No.: 11/528,838

(22) Filed: Sep. 26, 2006

(30) Foreign Application Priority Data
Sep. 28, 2005 (JP) 2005-283001

(51) Int. Cl. B29C 45/64; B29C 45/76

(52) U.S. Cl. 425/589; 425/149

(57) ABSTRACT

An injection molding machine includes a fixed mold, a movable mold capable of contacting to and separating from the fixed mold, and an injection unit which is provided to a non-molding face of the fixed mold and supplies molten resin to a space formed between the fixed mold and the movable mold. In the case the fixed mold and the movable mold are repeatedly opened and closed for continual molding, the molds firstly get contact with each other and clamped thereat and after that, the injection unit is made to press the non-molding face of the fixed mold. Furthermore, after releasing the pressure of the injection unit to the non-molding face of the fixed mold, clamping force to clamp the molds is released. Thus, there is provided an injection molding machine capable of avoiding shift of a fixed mold due to bending or tilting of a fixed platen and manufacturing optical elements with excellent anti-eccentricity at respective faces and high accuracy.

### CROSS-REFERENCE TO RELATED APPLICATIONS

This application is based upon and claims the benefit of priority from the prior Japanese Patent Application No. 2005-283001 filed on Sep. 28, 2005, the entire contents of which are incorporated herein by reference.

### BACKGROUND OF THE INVENTION

1. Field of the Invention

The present invention relates to an injection molding machine for molding an optical element with a mold. More particularly, it relates to an injection molding machine which avoids bending or tilting of a fixed platen so as to improve molding accuracy.

2. Description of the Related Art

There have conventionally been manufactured various molded items by injection molding. For example, JP Unexamined Patent Publication No. 10-323872 discloses an injection molding machine for molding disks utilized as information recording media. FIG. 4 shows schematic structure of the molding injection machine directed to the Publication No. 10-323872. The molding injection machine includes a fixed platen 101 and a cylinder 103. Four tie-bars 104 are laid between the fixed platen 101 and the cylinder 103 to link them. The tie-bars 104 are supporting a movable platen 105 which is slidable. The movable platen 105 is driven by the cylinder 103. A fixed mold 107 and a movable mold 108 are attached to the fixed platen 101 and the movable platen 105, respectively. The movable mold 108 is clamped to the fixed mold 107 by the cylinder 103. With this state, resin material is supplied from an injection unit 111 to mold a disk.

When injection molding is carried out by the injection molding machine, the injection unit 111 is pressed to the fixed platen 101 with predetermined force. Therefore, there has conventionally been devised such that the injection unit 111 has a driving means for making itself back and forth, i.e., in left-and-right direction in FIG. 4. For example, JP Unexamined Patent Publication No. 8-11175 discloses an injection unit equipped with a hydraulic cylinder as driving means. As other driving means for an injection unit, a ball screw is applicable. Instead of moving an injection unit back and forth, it has also been devised that a fixed platen is attracted to an injection unit with a hydraulic cylinder to make them contact with each other. For either conventional technique, improvement of molding accuracy and advancement of compact design have been demanded on micron-ordered injection molding machines of which clamping force is 150 kN or smaller.

In the case continual molding operations are to be carried out by the injection molding machine, the injection unit 111 is kept being pressed to the fixed platen 101 for continual molding operations, generally. That is, the movable platen 105 is driven for clamping, and resin is injected in there for molding. After cooled down, a molded item is taken out by opening the mold. It is repeated to drive the movable platen 105 for clamping. That is, the movable mold 108 is opened and closed with reference to the fixed mold 107 while nozzle touch pressure is kept applying to the injection unit 111 so as to keep contact with the fixed platen 101.

However, the above-mentioned conventional injection molding machines had a problem that the fixed platen 101 got bent or tilted when the molds were opened. For example, in the case the injection unit 111 is made to push the fixed platen 101 by a ball screw or the like, an upper portion of the fixed platen 101 could possibly get bent or tilted toward the movable platen 105 as indicated with broken lines in FIG. 5 when the molds were opened. At the next time of clamping with the thus bent or tilted fixed platen 101, mold shift occurred between the movable platen 105 and the movable mold 108 as shown in FIG. 6, which was problematic. Not to mention, FIG. 5 and FIG. 6 depict the bending and mold shift with some exaggeration.

Alternatively, in the case the fixed platen 101 is attracted toward the injection unit 111 by a hydraulic cylinder or the like, of the fixed platen 101, a portion around the hydraulic cylinder could possibly get bent or tilted to the side of the injection unit 111 as shown in FIG. 7. At the next time of clamping with the thus bent or tilted fixed platen 101, mold shift occurred between the movable platen 105 and the movable mold 108 as shown in FIG. 8, which was problematic. FIG. 7 and FIG. 8 show state of FIG. 4 viewed from its upper side. Not to mention, those figures depict the bending and mold shift with some exaggeration.

In the case next molding was carried out with the bent or tilted fixed platen 101 as described, it could possibly cause mold shift between the fixed platen 101 and the movable platen 105 at the time of meeting the molds, clamping, and the like and could possibly shorten a life of the mold, which was problematic. As the countermeasure of the above problems, the fixed platen 101 was thickened or support of the fixed platen 101 was arranged around its center so as to enhance mechanical rigidity. However, with such countermeasure, size of the machine was inevitably grown large, which was problematic. Especially, for a micro molding machine, there had been wanted an injection molding machine capable of realizing strict anti-eccentricity accuracy between both faces, down sizing while mechanical rigidity is secured, and continual molding of optical elements with high accuracy.

### SUMMARY OF THE INVENTION

The present invention has been attempted to solve the above-noted problems involved in the conventional injection molding machine. Thus, an object of the invention is to provide an injection molding machine capable of avoiding shift of a fixed mold due to bending or tilting of a fixed platen and manufacturing optical elements with excellent anti-eccentricity of both faces and high accuracy.

According to a first aspect of the present invention, there is provided an injection molding machine comprising: a fixed mold; a movable mold; an injection unit which supplies molten resin to a space formed between the fixed mold and the movable mold when being pressed to a non-molding face of the fixed mold; clamping mechanism which makes the movable mold contact with the fixed mold and clamps thereat; pressing mechanism which makes the injection unit press to the non-molding face of the fixed mold; and a controller which controls the clamping mechanism and the pressing mechanism such that the injection unit is pressed to the fixed mold only while the fixed mold and the movable mold are clamped, in the case the fixed mold and the movable mold are repeatedly opened and closed for continual molding.

According a second aspect of the present invention, there is provided an injection molding machine comprising: a fixed mold; a movable mold; an injection unit which supplies molten resin to a space formed between the fixed mold and the movable mold when being pressed to a non-molding face of the fixed mold; clamping mechanism which makes the movable mold contact with the fixed mold and clamps thereat; pressing mechanism which makes the injection unit press to the non-molding face of the fixed mold; and a controller which controls the clamping mechanism and the pressing mechanism such that the fixed mold and the movable mold are firstly clamped and after that, pressing force of the injection unit is applied to the non-molding face of the fixed mold in the case the fixed mold and the movable mold are repeatedly opened and closed for continual molding.

According a third aspect of the present invention, there is provided an injection molding machine comprising: a fixed mold; a movable mold; an injection unit which supplies molten resin to a space formed between the fixed mold and the movable mold when being pressed to a non-molding face of the fixed mold; clamping mechanism which makes the movable mold contact with the fixed mold and clamps thereat; pressing mechanism which makes the injection unit press to the non-molding face of the fixed mold; and a controller which controls the clamping mechanism and the pressing mechanism such that the pressure of the injection unit to the fixed mold is firstly released and after that, clamping force to clamp the fixed mold and the movable mold is released in the case the fixed mold and the movable mold are repeatedly opened and closed for continual molding.

According to the inventive injection molding machine directed to the first through third aspects, the injection unit is pressed to the non-molding face of the fixed mold by the pressing mechanism. Since the fixed mold has already been made to get contact with the movable mold and clamped thereat by the controller at this stage, the fixed mold and the movable mold are held together firmly. Furthermore, clamping force to clamp the molds is released after the pressure of the injection unit to the non-molding face of the fixed mold is released by the controller. Accordingly, the injection unit is made to press the fixed mold only while clamping force is applied to the molds. Thereby, there is provided an injection molding machine capable of avoiding shift of a fixed mold due to bending or tilting of a fixed platen and manufacturing optics with excellent anti-eccentricity at respective faces and high accuracy.

According a fourth aspect of the present invention, there is provided an injection molding machine comprising: a fixed mold; a movable mold which is capable of contacting to and separating from the fixed mold; an injection unit which is provided to a non-molding face of the fixed mold and supplies molten resin to a space formed between the fixed mold and the movable mold; and a pressing-force switching section which switches the pressing force of the injection unit to the fixed mold before an operation to open and close the fixed mold and the movable mold.

According to the fourth aspect, since the inventive injection molding machine has the pressing-force switching section, the pressing force of the injection unit to press the fixed mold is switched before an operation to open and close the fixed mold and the movable mold. Accordingly, the injection unit is made to press the fixed mold only while clamping force is applied to the molds. Thereby, there is provided an injection molding machine capable of avoiding shift of a fixed mold due to bending or tilting of a fixed platen and manufacturing optical elements with excellent anti-eccentricity at respective faces and high accuracy.

Thus, the inventive injection molding machine is capable of avoiding shift of a fixed mold due to fall or deflection of a fixed platen and manufacturing optics with excellent eccentricity at respective faces and high accuracy.

### BRIEF DESCRIPTION OF THE DRAWINGS

These and other objects and advantages of this invention will become more fully apparent from the following detailed description taken with the accompanying drawings in which:

FIG. 1 is a cross sectional view showing schematic structure of a lens molding device directed to an embodiment;

FIG. 2 is a diagram for illustrating displacement of a fixed platen directed to the embodiment when nozzle touch force is applied;

FIG. 3 is a diagram for illustrating displacement of a fixed platen directed to comparative example when nozzle touch force is applied;

FIG. 4 is a conceptual diagram of a conventional injection molding machine;

FIG. 5 is a front view of the conventional injection molding machine;

FIG. 6 is a front view of the conventional injection molding machine;

FIG. 7 is a plane view of the conventional injection molding machine; and

FIG. 8 is a plane view of the conventional injection molding machine.

### DETAILED DESCRIPTION OF THE PREFERRED EMBODIMENT

Preferred embodiments of the present invention will be described in detail below with reference to the accompanying drawings. In this embodiment, the present invention is applied to a lens molding device for manufacturing a plurality of lenses of a camera to be installed in a portable terminal at once. The lens molding device of the present embodiment is to mold a small optical element of which outside diameter is 12 mm or smaller, and an optical element to be mold is required to keep accuracy such as Ra 20 nm or smaller surface roughness of its optical surface. The present embodiment is applied to micro injection molding devices of which clamping force is 150 kN or lower.

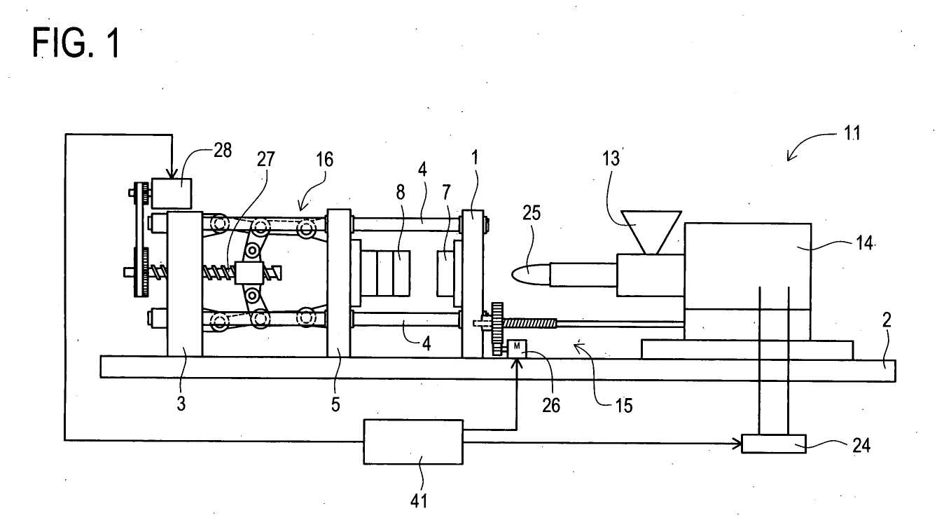

The lens molding device of the present embodiment is such structured as shown in FIG. 1. That is, a fixed platen 1 and a rear platen 3 are fixedly provided on a frame 2. Those platens 1 and 3 are substantially square shaped when looked from the left or right side with reference to FIG. 1. Four tie-bars 4 are laid between the fixed platen 1 and the rear platen 3 to link them. The tie-bars 4 are arranged at respective four corners of the fixed platen 1 and the rear platen 3 fixedly. They are arranged in parallel to one another.

A movable platen 5 is provided between the fixed platen 1 and the rear platen 3. The movable platen 5 is substantially square shaped when looked from the left or right side with reference to FIG. 1. Each tie-bar 4 penetrates through around each of four corners of the movable platen 5. The movable platen 5 stands on the frame 2 and is slidable to the four tie-bars 4. A fixed mold 7 is attached to a face of the fixed platen 1 facing the movable platen 5. A movable mold 8 is attached to a face of the movable platen 5 facing the fixed platen 1.

An injection unit 11 is provided at a rear side of the fixed platen 1 at the right side in FIG. 1. The injection unit 11 consists of a resin receiving portion 13, injection molding mechanism 14, nozzle touch mechanism 15, and a nozzle portion 25. A mold-controlling-and-clamping mechanism 16 is provided on the rear platen 3.

There is also provided a hydraulic servo 24 which drives the injection molding mechanism 14 and makes the mechanism inject molten resin into a space between the fixed mold 7 and the movable mold 8. The nozzle touch mechanism 15 has a nozzle touch motor 26 which makes the nozzle portion 25 press to the fixed platen 1 and keeps proper nozzle touch pressure while resin is injected. The mold-controlling-and-clamping mechanism 16 has a mold driving screw 27 for driving the movable mold 8, and a mold controlling motor 28 for controlling the mold driving screw 27.

In the present embodiment, there is provided a controller 41 for controlling the mold controlling motor 28, the nozzle touch motor 26, and the hydraulic servo 24. Thereby, the nozzle touch mechanism 15 and the mold-controlling-and-clamping mechanism 16 can be controlled integrally.

In the injection unit 11, resin is received at the resin receiving portion 13. Types of resin may be what are disclosed in JP Unexamined Patent Publications No. 2004-144951, No. 2004-144953, and No. 2004-144954, for example. The received and molten resin is measured by predetermined amount and collected in the nozzle portion 25 and its base portions. At the time of injection molding, the nozzle touch mechanism 15 presses the nozzle portion 25 to the fixed platen 1 with predetermined nozzle pressure. Nozzle touch pressure is about 5.1 kN, for example. The molten resin collected in the nozzle portion 25 is injected into a cavity formed between the fixed mold 7 and the movable mold 8.

Furthermore, the fixed platen 7 and the movable platen 8 are opened and closed by the mold-controlling-and-clamping mechanism 16. That is, the mold driving screw 27 is driven by the mold controlling motor 28, and the movable platen 5 is moved in left-and-right direction in FIG. 1. With a closed state in which the fixed mold 7 and the movable mold 8 meet with each other, those molds are clamped by the mold-controlling -and-clamping mechanism 16 with predetermined clamping force. The clamping force is about 68.8 kN, for example. In such a clamped state, molten resin is supplied to the cavity from the injection unit 11 to form lenses.

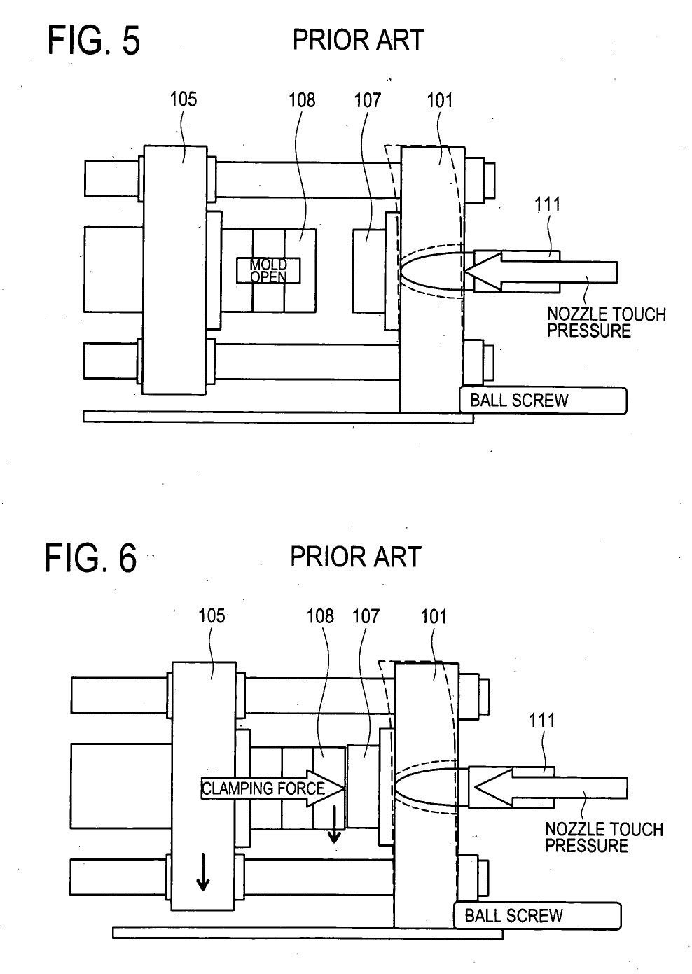

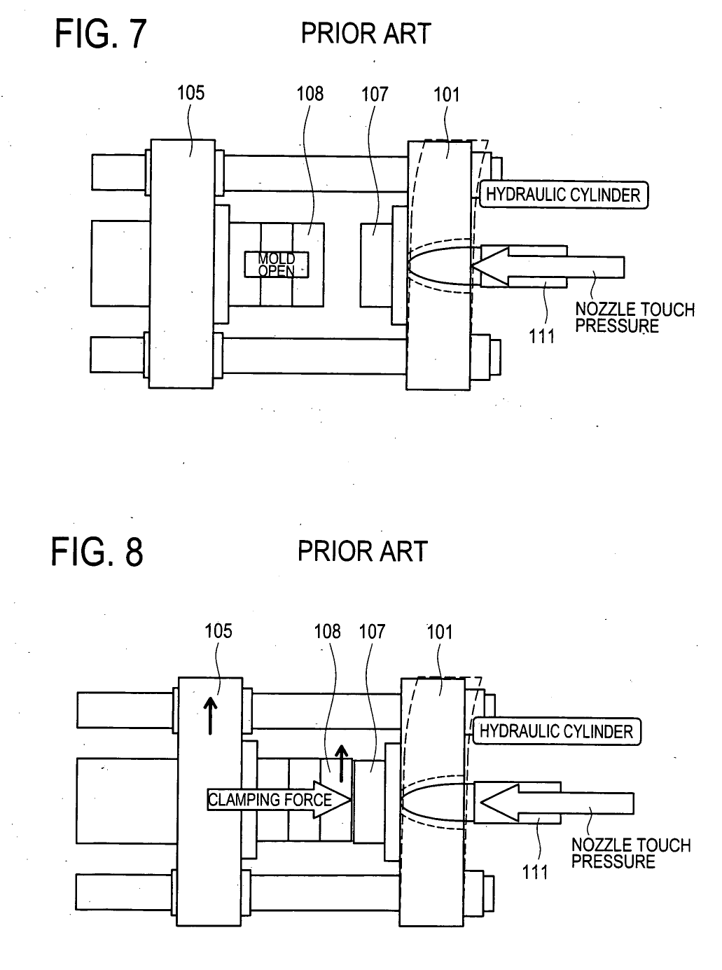

In the lens molding device of the present embodiment, drive of the injection unit 11 and that of the molds 7 and 8 are controlled by the controller 41. It is controlled such that nozzle touch pressure is applied only while the molds 7 and 8 are clamped. That is, operations are carried out in the following order: close molds; apply clamping force; apply nozzle touch force; inject resin; release nozzle touch force; release clamping force; and open molds. By operating in this order, nozzle touch force cannot be applied to the fixed platen 1 alone when clamping force is not applied there. That is, conventional problematic situations such as shown in FIG. 5 and FIG. 7 cannot occur to the present invention.

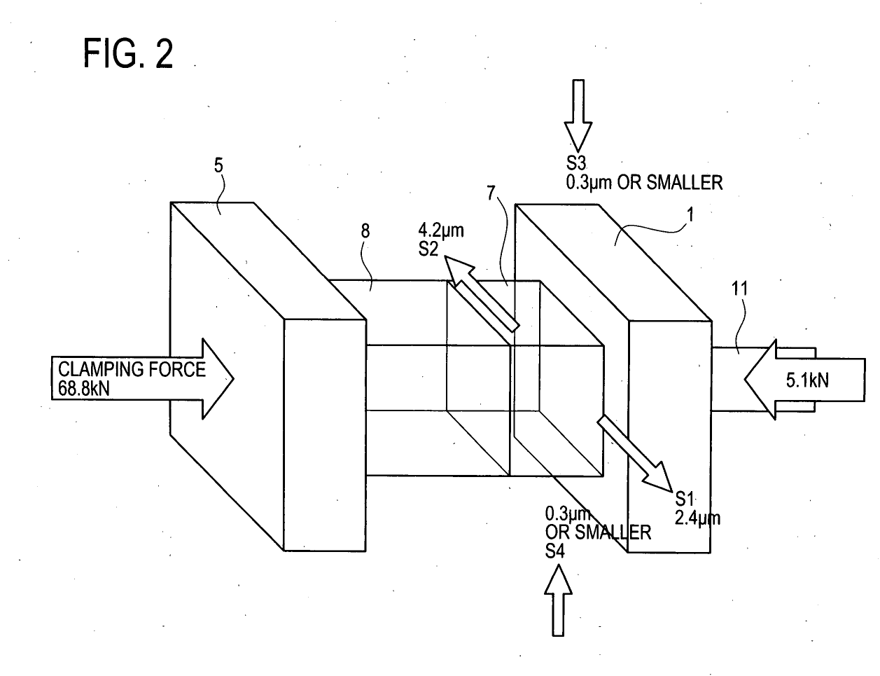

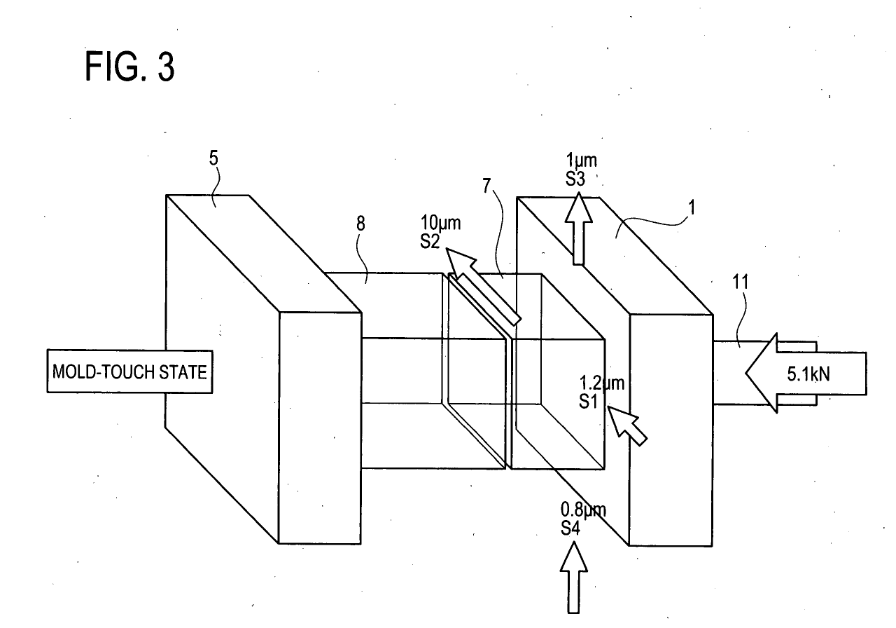

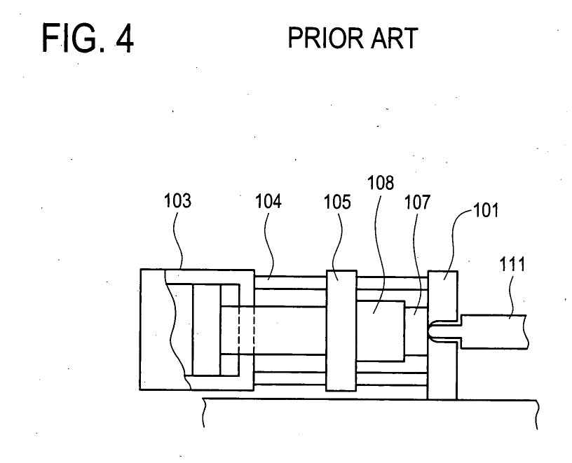

FIG. 2 shows a measurement result on displacement of the fixed platen 1 obtained when nozzle touch force is applied in a mold-clamped state. As comparative example, FIG. 3 shows a measurement result on displacement of the fixed platen 1 obtained when nozzle touch force is applied in a mold-touch state. Those measurement results are obtained in such a manner that application and release of nozzle touch pressure is repeated five times, obtained displacement of the five times are averaged, and the average is converted to a distance between tie-bars. Here, “mold-touch state” is a closed state in which a surface of the movable mold 8 and that of the fixed mold 7 meet with each other with little pressure being applied thereto.

In FIG. 2 and FIG. 3, an arrow S1 indicates displacement at the front face with reference to FIG. 1. Furthermore, arrows S2, S3, and S4 indicate displacement at the rear face, at the top face, and at the bottom face with reference to FIG. 1, respectively. Each of those arrows indicates displacement direction and each figure indicates displacement quantity. It is displacement around center of the fixed platen 1 that is most important. This is because a window is formed at substantial center of the fixed platen 1. Since the arrows S1 and S2 are quite opposite in direction, displacement in depth direction in FIG. 1 under mold-clamped state is to the degree of:
(4.2−2.4)/2=0.9 μm
Incidentally, displacement in up-and-down direction in FIG. 1 under mold-clamped state in is extremely little.

On the other hand, in the comparative example under mold-touch state, arrows S1 and S2 are same in direction in FIG. 3. Accordingly, displacement in depth direction is to the degree of:
(10+1.2)/2=5.6 μm
Incidentally, displacement in up-and-down direction under mold-touch state is to the degree of:
(1+0.8)/2=0.9=μm
From FIG. 2 and FIG. 3, it is apparent that displacement of the fixed platen 1 to which nozzle-touch pressure is applied under mold-clamped state is considerably little in comparison with mold-touch state.

As described, in the lens molding device and molding method directed to the present embodiment, it is always set in mold-clamped state when nozzle touch pressure is applied. Therefore, the fixed platen 1 does not get bent or tilted due to nozzle touch pressure. Thus, there is provided an injection molding machine and injection molding method in which shift of the fixed mold 7 due to bending or tilting of the fixed platen 1 is avoided and optical elements can be manufactured with excellent anti-eccentricity at respective faces and high accuracy.

The embodiments were described above merely as illustrative examples, but it is nothing to limit the invention in any way. Therefore, the invention can obviously be improved or modified in various ways without deviating from its essentials. For example, means for driving the movable platen 5 is not restricted to motors and screws. Hydraulic press system, hydraulic cylinder system, hydraulic toggle system, electric motor type cylinder system, electric-motor-drive toggle system, whatever, may be applicable. Opening and closing molds and mold clamping under mold-closed state may be done by separate mechanism.

Furthermore, drive system of the nozzle touch mechanism 15 may be hydraulic system. Alternatively, it may be system to press the injection unit 11 to the fixed platen 1 with ball screws or the like, or system to attract the fixed platen 1 toward the injection unit 11 with a hydraulic cylinder or the like. Furthermore, plural driving portions for applying nozzle touch pressure may be provided and nozzle touch pressure may be applied by two or more of them.

Furthermore, the present invention is applicable to a tie-bar-support type lens molding device in which load of the movable platen 5 is supported by the tie-bars 4. The lens molding device may have an auxiliary supporter such as LM guide or the like. The number of tie-bars is not restricted to “4”.

What is claimed is:

1. An injection molding machine comprising:
a fixed mold;
a movable mold;
an injection unit which supplies molten resin to a space formed between the fixed mold and the movable mold when being pressed to a non-molding face of the fixed mold;
clamping mechanism which makes the movable mold contact with the fixed mold and clamps thereat;
pressing mechanism which makes the injection unit press to the non-molding face of the fixed mold; and
a controller which controls the clamping mechanism and the pressing mechanism such that the injection unit is pressed to the fixed mold only while the fixed mold and the movable mold are clamped, in the case the fixed mold and the movable mold are repeatedly opened and closed for continual molding

2. An injection molding machine according to claim 1,
wherein the controller controls the clamping mechanism and the pressing mechanism such that the pressure of the injection unit to the non-molding face of the fixed mold is firstly released and after that, clamping force to clamp the fixed mold and the movable mold is released in the case clamping of the fixed mold and the movable mold is released during continual molding.

3. An injection molding machine according to claim 1,
wherein the controller controls the clamping mechanism and the pressing mechanism such that the fixed mold and the movable mold are firstly clamped and after that, pressing force of the injection unit to the fixed mold is applied in the case the injection unit is pressed to the fixed mold during continual molding.

4. An injection molding machine according to claim 1,
wherein plural optical elements are formed simultaneously.

5. An injection molding machine according to claim 4,
wherein the injection molding machine forms optical elements of which outside diameter is 12 mm or smaller and surface roughness is Ra 20 nm or smaller.

6. An injection molding machine comprising:
a fixed mold;
a movable mold;
an injection unit which supplies molten resin to a space formed between the fixed mold and the movable mold when being pressed to a non-molding face of the fixed mold;
clamping mechanism which makes the movable mold contact with the fixed mold and clamps thereat;
pressing mechanism which makes the injection unit press to the non-molding face of the fixed mold; and
a controller which controls the clamping mechanism and the pressing mechanism such that the fixed mold and the movable mold are firstly clamped and after that, pressing force of the injection unit is applied to the non-molding face of the fixed mold in the case the fixed mold and the movable mold are repeatedly opened and closed for continual molding

7. An injection molding machine according to claim 6,
wherein the controller controls the clamping mechanism and the pressing mechanism such that the pressure of the injection unit to the fixed mold is firstly released and after that, clamping force to clamp the fixed mold and the movable mold is released in the case the fixed mold and the movable mold are repeatedly opened and closed for continual molding.

8. An injection molding machine according to claim 6, wherein plural optical elements are formed simultaneously.

9. An injection molding machine according to claim 8,
wherein the injection molding machine forms optical elements of which outside diameter is 12 mm or smaller and surface roughness is Ra 20 nm or smaller.

10. An injection molding machine comprising:
a fixed mold;
a movable mold;
an injection unit which supplies molten resin to a space formed between the fixed mold and the movable mold when being pressed to a non-molding face of the fixed mold;
clamping mechanism which makes the movable mold contact with the fixed mold and clamps thereat;
pressing mechanism which makes the injection unit press to the non-molding face of the fixed mold; and
a controller which controls the clamping mechanism and the pressing mechanism such that the pressure of the injection unit to the fixed mold is firstly released and after that, clamping force to clamp the fixed mold and the movable mold is released in the case the fixed mold and the movable mold are repeatedly opened and closed for continual molding.

11. An injection molding machine according to claim 10,
wherein plural optical elements are formed simultaneously.

12. An injection molding machine according to claim 11, wherein the injection molding machine forms optical elements of which outside diameter is 12 mm or smaller and surface roughness is Ra 20 nm or smaller.

13. An injection molding machine comprising:
a fixed mold;
a movable mold which is capable of contacting to and separating from the fixed mold;
an injection unit which is provided to a non-molding face of the fixed mold and supplies molten resin to a space formed between the fixed mold and the movable mold; and
a pressing-force switching section which switches the pressing force of the injection unit to the fixed mold before an operation to open and close the fixed mold and the movable mold.
